(19) United States
(12) Patent Application Publication
(10) Pub. No.: US 2003/0074475 A1
(43) Pub. Date: Apr. 17, 2003

(54) Mulitnode server

(76) Inventor: Ville J. Ollikainen, Helsinki (FI)

Correspondence Address: MERCHANT & GOULD PC, P.O. BOX 2903, MINNEAPOLIS, MN, 55402-0903, US

(21) Appl. No.: 10/168,649

(22) PCT Filed: Dec. 21, 2000
(86) PCT No.: PCT/FI00/01136

(51) Int. Cl. G06F 15/16

(52) U.S. Cl. 709/246; 709/238

(57) ABSTRACT

The server comprises a plurality of nodes and links connecting the nodes. Each node can serve a single user or multiple users. A data storage means (42) in the node is designed to serve not only its own users but also other nodes of the decentralized file server so that files incoming to the node can be distributed forward to at least two other nodes of the server. A file fetched by several users simultaneously is copied automatically into a plurality of nodes in the file server. The nodes have conversion means (44) for converting a file requested by a user from one type to another type. The conversion can only be carried out in the node the user is connected to. Calculation capacity for executing the conversion can also be decentralized to several nodes. This is especially advantageous when the calculation load for the processor in one node is very high due to various simultaneous conversion processes.

### FIELD OF THE INVENTION

The present invention relates to a server comprising a plurality of nodes and a plurality of links for connecting each node to at least two other nodes. Each node includes data storage means for storing files, at least one data connection for communicating with a user connected to the node, and a routing matrix for routing stored files to other nodes, and for routing incoming files to other nodes.

### BACKGROUND ART

A scalable server for delivering information to the users can be built by storing information, such as data files, audio or video files, in disks arrayed in several units. Information to be loaded in disks is obtained from service providers via I/O modules. Each module and commutator stripe incoming data to the controllers of the disk array units and the controllers load data to the disks in accordance with the used RAID system. In the opposite direction information is retrieved from the disk array units and compiled in the I/O unit before transmission to the user.

In another scalable media server the main information storage is a content server which is connected to a LAN network. A file to be downloaded into a user is copied from the centralized main storage unit through the LAN to a buffer, from which information is further downloaded to the user. Downloading might be started already during the copying process. Scalability is obtained by adding new buffers.

It is also known to decentralize information to a plurality of servers which are interconnected through the LAN. If the requested file for starting playback is unavailable in the buffer in question, the file is copied via the LAN from another server. Copying can be carried out before starting playback of the file, i.e. before downloading into a user, or downloading can be started during copying process. Scalability is obtained by adding new servers.

It is also known to interconnect servers with fixed and fast lines. Then information exchange between the servers can be much faster than what is possible by using the LAN. However, by increasing the number of servers the number of fixed lines grows rapidly, which leads to difficulties in controlling the system. Nevertheless, this kind of video server, which can be called a networked video server, has recently made its way into facilities in the broadcast industry, as networking a few small servers together produces a fault tolerant system with high reliability.

FIG. 1 depicts an effective video server structure which is described in the European patent application no: 97926027.0. The server according to the present invention is based on that kind of server structure, and therefore the structure and operation of the server will be described in more detail.

The server comprises of a plurality of nodes; in figure eight nodes are shown. In practice, each of the nodes comprises of a plug-in unit inserted into a slot in a subrack. The plug-in unit or the node includes a storage unit, which is preferably a hard disk, a routing matrix, and the necessary control electronics. A detailed description of these elements is given later. Further, each node has a unique address. At least one user line can be connected to every node. One or more of the nodes are further connected to a media source. This can be a central storage unit connected to the server and which includes media offered to users. It can also be a remote source accessible via a transmission network. Media can consist of data files, text files, audio and video files, etc.

The nodes are interconnected via links so that one node is connected with more than one of another nodes. If the nodes are plug-in units, the best way to implement the links is to place them onto the back plane of the rack. The preferred way to logically establish connecting links between nodes will be explained later.

The basic operation principle of the multinode server is as follows:

For example user A, which is connected to node 8, requests the server to download a file, let's say a video clip. The requested file is fetched from central storage 11 or from another source, the entry point to the server being node 7. Routing matrix 12 in this node routes the requested file towards node 8. There, routing matrix 13 routes the file to storage 14. The storage, which is preferably a hard disk, stores the file. Not until now can the file be downloaded to user A.

It is highly essential to note that the requested video clip as a whole, or at least a part of it, is first stored in the storage unit of the node, and the user connected to the node can obtain information only by reading the content of the storage unit.

After user A has downloaded and watched the video clip, a copy of it will still remain in storage 14.

Next, user B connected to node 3 requests the same video clip as user A did earlier. The control system (not shown in the figure) of the server knows that the nearest place where the video clip is retrievable is storage 14 of node A. Due to the fact that all the nodes are interconnected with the links, the control system instructs node 8 to send the video clip to node 3. In this example, the video clip is first routed via link A to node 4. Routing matrix 15 of that node in turn routes the clip via link B to node 3. There, routing matrix 18 routes the video clip to storage 17, from which the user can download the file. Downloading can begin either after the completed storing process or after the storing process has started and at least a part of the file is stored.

Thus, the video clip is stored in and available from two nodes of the server, namely in node 8 and in node 3. In the manner described above the amount of nodes comprising the copy of the video clip increases as the number of users requesting it increases. As a result, the more users that have had the same video clip the faster a new user can obtain it.

FIG. 2 shows an example of the internal structure of the node described in the above-mentioned EP application. The node has three different main functions: firstly, it operates as a routing channel between the other nodes; secondly, it provides means for data transfer from the node to users connected to the node; and thirdly, it stores data in its memory for further distribution. For the purposes mentioned above, the node includes at least routing matrix 21, data storage means 22, and controller 23. In addition, the node also includes output connection lines O1, O2, . . . , On for transferring data from data storage means 22 to routing matrix 21 and input connection lines I1, I2, . . . , In for transfering data from routing matrix 21 to data storage means 22. Further, the node is provided with at least one data interface U1, U2, . . . , Uk, through which data are transmitted to and received from users.

Links 8 and 9, which connect the node to other similar nodes or data transfer devices, are connected to routing matrix 21. Hence, the routing matrix is capable of routing data transfers from or to other nodes or data transfer devices. If the incoming data is addressed to the node itself, the matrix routes the incoming data to input connection lines I1, I2, . . . , In, wherein data will be stored in data storage means 22. If data stored in the data storage means is to be transferred to another node of the server, it will be sent through output connection lines O1, O2, . . . , On to routing matrix 21. The routing matrix connects one of the output connection lines to one or more outgoing channels of link 9. It should be noted that a plurality of data streams can be carried in any one connection line.

Data storage means 23 is formed by a magnetic, optical, or solid state memory. The data storage means is associated with controller CTRL 23, serving both the data connections for delivering data contained in data storage means 22 to at least one immediate user 5 through data interfaces U1, U2, . . . , Uk, and at least one input line 7, as well as at least two outputs, in one or more physical lines 6, connected to routing matrix 21. The data storage means has sufficient capacity to store the data of at least one continuously playable video and/or audio sequence of an average length.

Controller 23 is suited for controlling the functions of data storage means 22 and routing matrix 21. In addition, the controller is capable of receiving control data from the assigned users of the node and from any central management system through the appropriate connection 210.

As a result of the node construction described above, the node has the capability of distributing data from its data storage means simultaneously to both the assigned users connected to the node and to at least two other nodes having access to the data transfer units. It also has the capability of routing data transfer from the inputs to the node and to the outputs from the node whenever it does not need access to the contents of the transferred data. Further, the node is capable of storing a file into its data storage means whenever the node has an internal need for gaining access to the transferred data. The node is able to start delivery of a file to other nodes and to the users even if the entire content of the file has not yet been copied into the data storage of the node.

The server construction explained above does not set any limitations on just how the nodes are interconnected to form a file server. However, the best way is to use hypercube architecture.

A 0-dimensional hypercube has only one node. A 1-dimensional hypercube is formed by copying the original node and putting data links between these two nodes. A 2-dimensional hypercube is formed by copying the template, i.e. the 1-dimensional cube, and putting links between the respective old and new nodes. A 3-dimensional cube is formed by copying the 2-dimensional cube putting links between the respective nodes. Hence, an N-dimensional hypercube can be formed by copying a N-1 dimensional hypercube and connecting the corresponding nodes with data links.

FIG. 3 depicts a server having 5-dimensional hypercube architecture. The operation of the server will now be explained. When a user requests a file, his node 333 contacts central management system 326, which checks which one(s) of nodes 330, 335, 336 have the requested file. It notes that the requested file was recently copied from node 330 to nodes 335 and 336. In consequence, a route is established from the closest routable node 335 to the user's node 333, and the replicating data transfer is initiated. Immediately at the beginning of the replicating data transfer, the central management system 326 registers the requested file that is also available from the user's node 333. As a result, files requested simultaneously by a plurality of users will be simultaneously available in real time from nodes 335, 336, 333 to the new node 337 requesting the file in question.

Data communication nodes 323, 324 are able to transfer the files, e.g., from external servers or from a high-capacity data storage device.

One drawback of the multinode video server, as in any other of today's file distributing servers is that it only transfers files to users, without paying attention to the format of the file to be transferred. The appropriate software has to be installed in the user's terminal so that it is able to receive and further process the file received. If a service provider should upgrade the software, the user must also install the new version of the software in the terminal to be able to use the upgraded version. Today there are several file types downloadable from the internet. As a result of this, the user must have software programs which are able to read all or at least a majority of the file types.

A second drawback is that differences among browsers of terminals or terminals itself cannot be taken into consideration. There are different types of browsers: a browser in a personal computer, in a personal digital assistant (PDA), or in a WAP phone differ from one another as do also the terminals. For example, pictures cannot be displayed with same resolution due to the different sizes of the displays.

### SUMMARY OF THE INVENTION

One objective of the present invention is to devise a server which processes data, before sending it to a terminal, in such a manner that data is maximally adapted to the terminal concerned by taking into account the terminal's software, display size, transmission protocol etc. For example, processing data includes the conversion of files from one format to another so that the terminal can run software programs of versions which are older than those delivered by a service provider and process files of different formats according to the limited capacity of the terminal to handle various types of different files.

This objective is accomplished by a multinode server, in which a plurality of nodes has conversion means for converting a file requested by the terminal from one type to another. In another words, if the format of the requested file is a type that the terminal is unable to handle, the format is changed to a format, which the terminal is able to handle and display.

The user's terminal informs the server of the file formats that it is able to handle, either in its download request or at the beginning of the session. Alternatively, information about the formats which terminals are able to handle can be stored in a database of the multinode server or retrieved from an external server.

Conversion can be carried out only in a node to which the terminal is connected. However, calculation capacity for executing the conversion can also be decentralized to several nodes. This is especially advantageous if the calculation load to the processor in one node is very high due to various simultaneous conversion processes.

In addition, some nodes can be assigned for certain conversion processes only. In that case the node has very high calculation capacity, and other nodes can share its capacity.

Further, the nodes that perform similar conversion tasks or store similar conversion results are located near each other in the server topology to form a node group. The user terminals that require same kind of conversion are connected to the same node group. The arrangement is advantageous because when a terminal requests a certain conversion it is very likely that the conversion has already done for another user terminal and the conversion result is still obtainable from the memory of the node.

The proposed multinode server allows centralization of program upgrading, wherein the need for upgrading terminals decreases. In addition, there are many calculation tasks that are performed by the server, which means there is no need to provide the terminal with excessive calculation capacity.

The internal structure of a multinode server allows to routing of data from one node to another along a plurality of alternative routes. Hence, if a data transfer route in a subcube occasionally reserves the maximum data transfer capacity of a link chain and thus prevents the use of those links for data transfers of another nodes, then other data transfers are processed via the remaining free links in alternate periods of time. Therefore, each of the data transfers has its own routing figure, and the figures alternate in time .

### BRIEF DESCRIPTION OF THE DRAWINGS

The invention is described more closely with reference to the accompanying drawings, in which:

FIG. 1 presents a basic principle of a known multinode server;

FIG. 2 depicts the structure of the node;

FIG. 3 shows a server having 5-dimensional hypercube architecture;

FIG. 4 illustrates a schematic diagram of a multinode server in accordance with the invention;

FIG. 5 depicts the structure of the node;

FIG. 6 shows conversion operation in a node;

FIG. 7 illustrates the use of the multinode server,

FIG. 8 illustrated information exchange between the terminal and the server,

FIG. 9 shows data routes of the first alternation figure, and

FIG. 10 shows data routes of the second alternation figure.

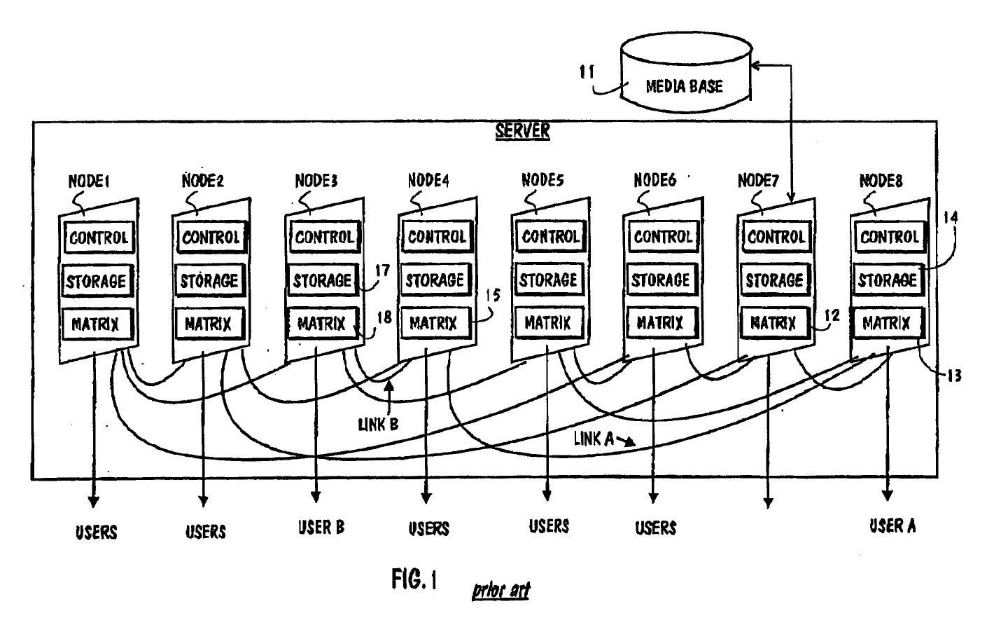

### DETAILED DESCRIPTION OF THE INVENTION

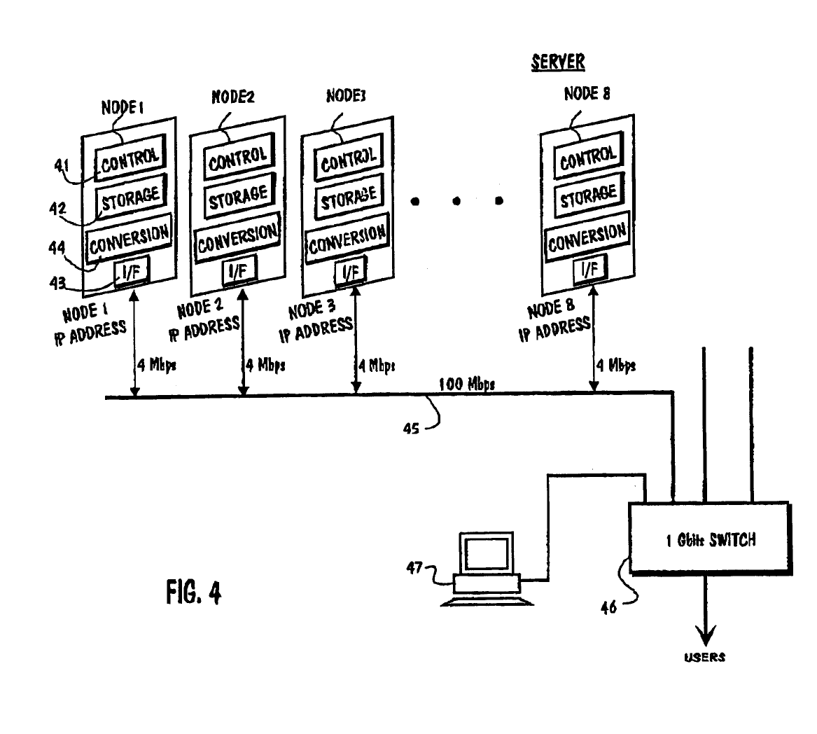

The server structure in FIG. 4 is similar to the structure of the known multinode server. For clarity, internal links connecting the nodes are omitted. Hence, it comprises a plurality of nodes; in this example there are eight nodes. Each node consists of control means 41, storage means 42, and interface means 43. The control means, which is preferably a central processor, controls the internal operation of the node. The storage means, which is preferably a hard disk or a flash memory, stores data received from other nodes or from an external source. The interface means (I/F) handles traffic to and from the node.

In addition, the node also contains conversion means 44. The main task of the conversion means is to convert data stored in the storage means to another format. Conversion is carried out prior to delivering the data to a user requesting said data when the user's terminal is not capable of handling the data in the same format as the server has.

Format conversion may be the simple conversion from one program version to another, whereupon, for example, a file produced with a new version of a program is converted into the old version of the program. In that case the program in the terminal does not need to be upgraded in order to be able to open the file of the new version it has received.

Format conversion may also be file type conversion. For example, the terminal can handle only audio files of the WAV type. However, a service provider offers audio files of the MP3 type. In that case, the conversion means convert the MP3 audio file to a WAV audio file. On the other hand, if the terminal is able to handle MP3 files but there is not enough bandwidth in the server for transfering WAV files, the Wav files are converted to MP3 files.

Format conversion may also be a protocol conversion. In that case a protocol of data in storage means 41 is converted to a protocol type whereby the terminal is able to receive and process said data. One example of this is a browser. If the terminal is provided with a browser which supports a protocol named Wireless Access Protocol (WAP), it can receive pages coded with WML (Wireless Markup Language), but it cannot receive html pages conveyed with www protocol. In such cases, the conversion means carries out conversion from www to WAV and html to WML.

In FIG. 4 the nodes are interconnected via 100 Mbps bus 45, to and from which each node can transmit and receive data with a bit rate of 4 Mbps. The bus is connected to fast switch 46, here 1 Gbits, which routes user data to nodes based on their respective addresses and from nodes to users. In addition, several buses with attached nodes can be connected to the switch when the server includes large amounts of nodes. Note that the internal traffic among nodes is conveyed via the links, which are not shown in the figure.

Central management system 47 controls the operation of the server and checks which of the nodes have the file requested by the user.

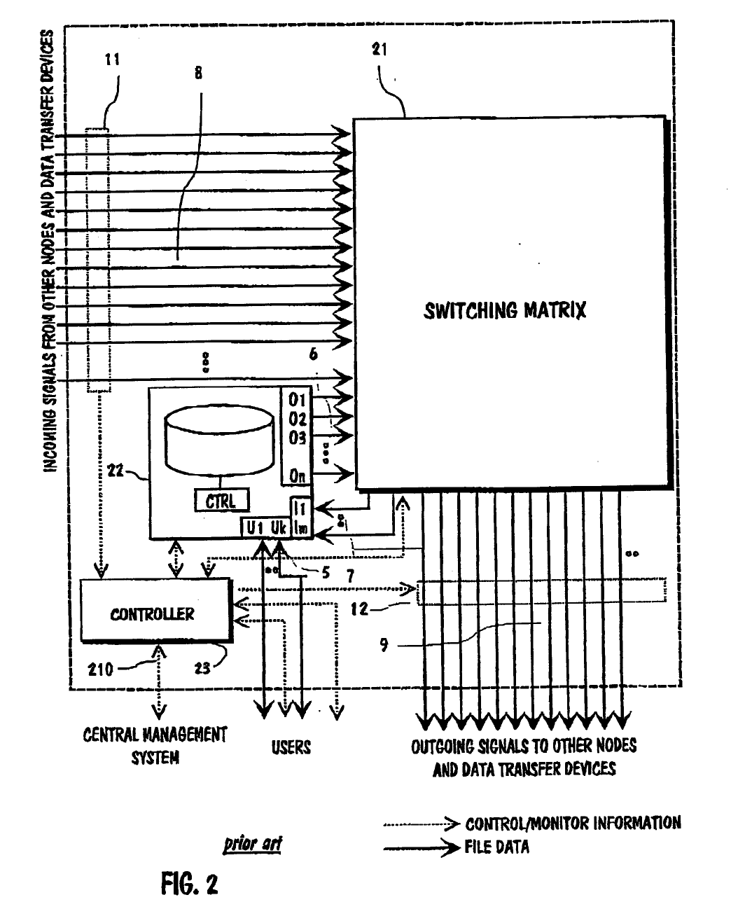

FIG. 5 depicts one possible structure of a node. Here the node belongs to a server with hypercube architecture and uses the switching matrix as shown in FIG. 2. Hard disk 52, format conversion block 54, processor unit 53, and user interface 55 are connected to common bus 56, which in turn transmits data to and receives data from switching matrix 51. If the processor unit has enough capacity to perform format conversions, the format conversion block can be based on software and it can be an integral part of the software of the processor unit. This type of construction is known to those skilled in the art.

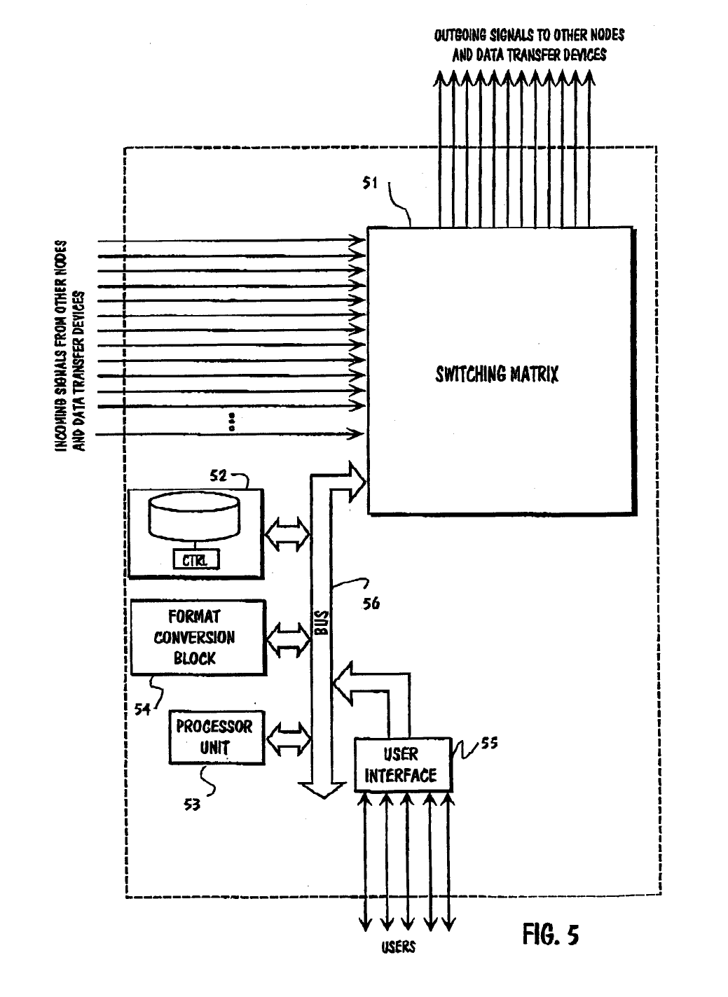

The conversion process will now be explained in more detail with reference to FIG. 6. For clarity and better understanding of the conversion, the figure illustrates only two adjacent nodes of the multinode server.

As a starting point, let us assume that user A in node A has requested a file, a www page, for example, and the requested file has been received via link A and stored in whole or at least partially in hard disk 61. The file format is not suitable for user A, so that conversion is required.

The data in hard disk 61 is supplied to format conversion block 62, which carries out conversion. The converted data can be transmitted, depending on the data and conversion rates, directly to user A, or the converted data can be buffered in hard disk 61. If presentation of the converted data requires more bits per second or more bandwidth than either link A, through which the requested data is supplied to node A, can offer or conversion block 62 can produce, enough converted data must be stored in the buffer, i.e. on hard disk 61, before starting the presentation so that presentation at the user's end can be carried out from the beginning to the end without interruptions. Four basic modes can be distinguished.

First, if the rate of data incoming to node A is slower than the bandwidth of supplying link A and if conversion can be performed at the minimum rate required for presentation, then the converted data is transmitted directly to user A without buffering on disk 61.

Secondly, if the rate of incoming data is slower than the bandwidth of supplying link A but conversion cannot be performed at the minimum rate, a piece of converted data must be buffered on disk 61. The amount of buffered data must be enough in order to assure trouble-free presentation at the terminal of user A.

Thirdly, if the rate of incoming data is higher than the bandwidth between nodes, i.e. than the data rate of link A, but it is sufficient to carry out conversion in block 62 at minimum speed, and if the amount of converted data, i.e. the size of the converted file, is smaller than the amount of original data, i.e. than the original file, then the converted data must be stored on disk 61. However, if the amount of converted data is greater than the original data, then preferably only the original data is buffered on disk 61.

Finally, if the rate of incoming data is higher than the bandwidth of link A and conversion cannot be performed at the required minimum speed, then enough converted data is buffered on disk 61 so that trouble-free presentation is possible at the user A's end.

The options explained above concern cases in which the file requested by the user is fetched from an external data base, i. e. the file is not available from one or several nodes of the multinode server. However, after the file has been sent to node A, the unconverted file and the converted file are stored on disk 61 in node A. The files are then available to all other users connected to other nodes of the multinode server.

If user B, who is connected to node B, requests a converted file described above, there are two ways to proceed. Namely, either the unconverted file is delivered from node A to node B and conversion is carried out by format conversion block 622 of node B, or the already converted file is delivered from node A via link B to node B. How to proceed depends on some limiting conditions. Four possible cases can be distinguished:

First, if the trouble-free presentation of the converted data at user B's end does not require a higher bit rate than link B can offer, and if the size of the converted file stored in node A is smaller than the size of the original file, then the converted file is always fetched from node A whenever conversion cannot be performed by conversion block 622 in node B at the minimum rate. However, if conversion can be carried out at the minimum rate, the original file is fetched from node A so that the original file can be put to more general use.

Secondly, if the trouble-free presentation of the converted data at user B's end does not require a higher bit rate than link B can offer, and if the size of the converted file stored in node A is larger than the size of the original file, then the original (unconverted) file is fetched from node A whenever conversion can be performed at a minimum rate by conversion block 622 in node B.

Whenever conversion cannot be carried out at minimum rate then the converted file is fetched.

Thirdly, if trouble-free presentation of the converted data at the user B's end requires a higher bit rate than link B can offer, but the size of the converted file stored in node A is smaller than the size of the original file, then the converted file is fetched from node A.

Finally, if the trouble-free presentation of the converted data at user B's end requires a higher bit rate than link B can offer, and if the size of the converted file stored in node A is larger than the size of the original file, then the original (unconverted) file is fetched from node A providing that conversion can be performed at the minimum rate by conversion block 622 in node B. Whenever conversion cannot be carried out at the minimum rate, the file is fetched, which allows to be started presentation faster, when the transfer rate between the nodes and conversion rate in the node are taken into account.

The nodes of the multinode server of a simple type can be identical which means that the conversion unit of each node is capable of performing the same tasks but is not able to offer conversion services to other nodes. However, it is advantageous to share conversion resources among the nodes so that one node can use the conversion resources of other nodes when necessary. In some applications it would be advantageous to build up special nodes which are intended for specific conversion purposes only. These nodes can carry out complex conversions demanding high calculation capacity very fast, and other nodes can order services from these nodes. The special nodes are best located near the nodes most frequently using the resources of the special nodes.

Furthermore, in order to maximize the speed of conversion it is advantageous that the nodes using same kind of conversion are located near one another. Then the user terminals calling for that type of conversion are connected to these nodes.

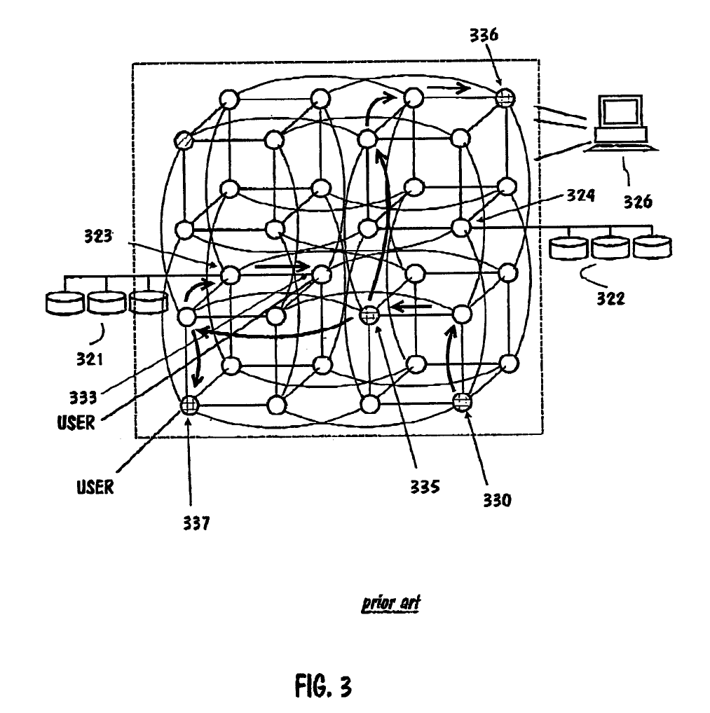

If the structure of the multinode server is hypecubic, as shown in FIG. 3, the nodes of a subcube can be specialized in tasks necessitating the same type of data and calculation resources.

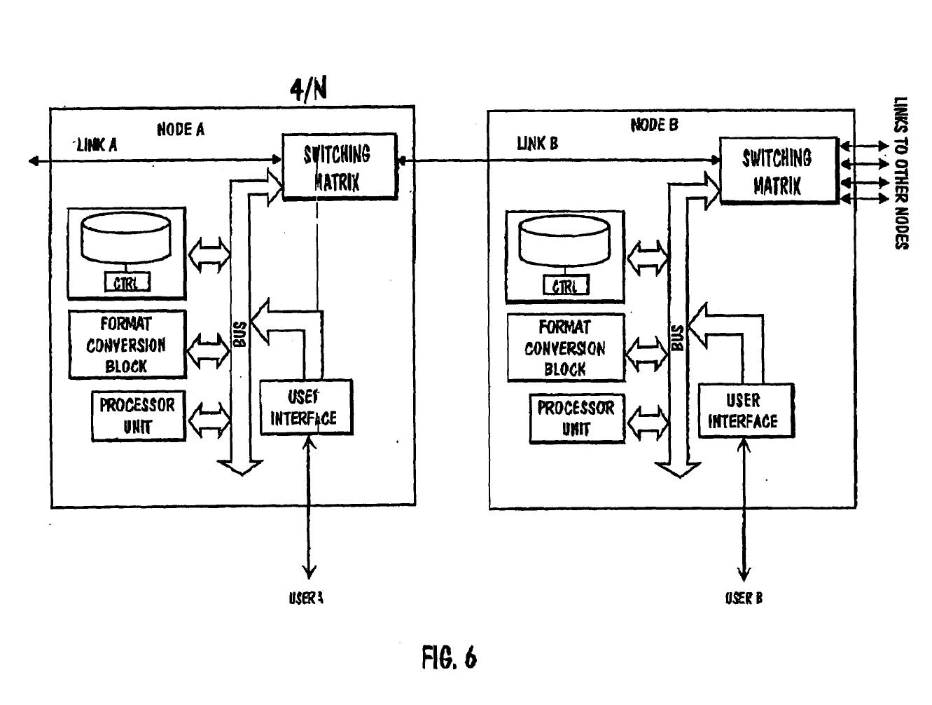

FIG. 7 depicts the use of the multinode server. Here the user can be a subscriber of a mobile network using a mobile phone operating with WAP protocol. Such a phone is called a WAP phone. The user can use the browser of the phone to receive files according to the WAP protocol or pages coded with wireless markup language (WML pages). In comparison to browsers installed in personal computers and capable of handling complex files, a WAP browser can handle rather simple files. Phone 70 is connected through mobile network 71 to a node of multinode server 72 offering WAP services. In addition, server 72 can fetch files from internet network 73 for downloading to phone 70. Quite often the fetched file is not in such a format that WAP phone 70 could handle it. Resolution of a GIF picture or HTML document might be too high, for example. In that case the format conversion unit of the multinode server carries out conversion into a format which the WAP phone can handle and which is suitable for transmission through the radio interface. Conversion may be both protocol conversion from http to WAP and coding conversion from html or xtml to xml. In such cases the multinode server acts as a proxy.

Moreover, personal computer 74 can be connected via a PSTN/ISDN network to a node of the multinode server. If the browser of the personal computer cannot handle the downloaded pages or if the format of the downloaded file is of a newer version than the program which is supposed to open it, conversion into a suitable format is performed in the multinode server.

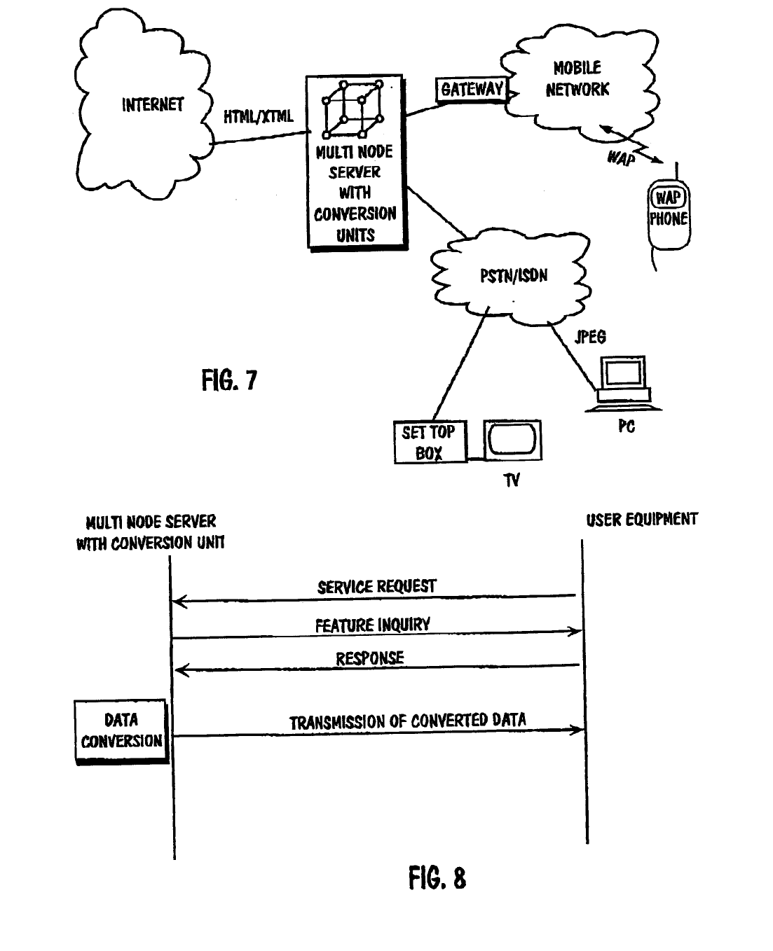

In order for multinode server to begin the conversion process, it has to have knowledge of the features of the terminal. Hence, at the beginning of the session the terminal has to send information about itself. One general way to commit information to the multinode server is illustrated in FIG. 8.

The terminal begins the session by sending a service request to the multinode server. In the request the terminal can send its feature information as in the case of a web browser, wherein the browser attaches a special header called User-Agent Header into the page request. This header contains information about the browser type.

If the service request does not contain enough information about the terminal, the multinode server can send a feature inquiry to it. Said inquiry might be a Java applet or a Java script, for example, which sends to the multinode server a response message after execution, with information about the terminal features. After the server has collected enough knowledge of the terminal, it can perform conversions when necessary.

During web surfing the browser also sends with every page request headers called Accept, Accept-Encoding, and Accept-Language. Using information embedded within these headers, the multinode server is able to choose the best page format for the browser and thus convert every page to be sent into the most suitable form for the browser.

However, in many cases the feature information which the browser sends to the server is not sufficient. This is especially in cases where a PDA device (Personal Digital Assistant) is involved, because those devices have limited memory, limited processing capacity, and a small display size. But PDA devices also send with each page request a header containing some information about the device type. Providing that the server includes a data base consisting of information about all the device types, the server is capable of retrieving additional information from the data base and making conversions accordingly.

When the multinode server has a hypercube structure, alternations of internal data transfer routes in a subcube can be advantageous. For example, one data transfer route may temporarily occupy all the capacity of three subsequent links of a subcube. This means that other data transfer routes cannot be set up via these links and under certain circumstances, it is impossible without alternation to set up a data transfer route until the temporary blockage has vanished. The alternation will be explained hereafter.

FIG. 9 depicts a subcube of a multinode server with a plurality of subcubes. The subcube is 4-dimensional, comprising eight nodes and links connecting the nodes. One data transfer route, denoted as 91, begins from transmitting node T1, goes through nodes B and C, and ends at receiving node R1, where data is converted prior to delivery to user 1.

Another data flow 92 begins from transmitting node T2, goes through node D and ends at receiving node R2. Data flow 92 is converted at end node R2 prior to delivery to the user.

Let us assume that transmitting node T2 is connected to an external data base, so that node T2 is the access node to the subcube. Data flow 92 is obtained from the external data base.

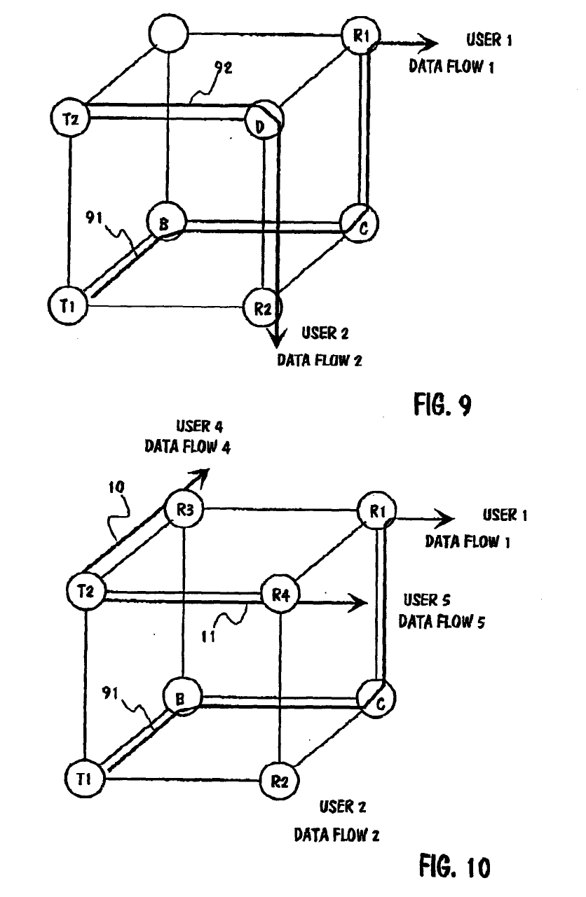

Reference is made to FIG. 10. What happens if user 4 connected to node E and user 5 connected to node D have requested files from the same access node. Apparently, the requested file can be routed to user 4 directly from node T2 without routing through intermediate nodes. The requested file cannot be routed to user 5 directly or through nodes T1 and R3 because data stream 92 has fully reserved the capacity of links T2→D and R2→D (see FIG. 9).

Therefore, data stream 92 is stopped for a while and data streams 10 and 11 are started. As a result, user 2 obtains data stream 10 and user 5 connected to the receiving node obtains data stream 5. Again, after a predetermined time period, data streams 10 and 11 are stopped and the transfer of data stream 92 continues. In this manner the stream figures formed by stream 92 on one hand, and streams 10 and 11 on the other hand, alternate periodically.

Alternation is controlled by the centralized control system of the multinode server, which also controls the internal data transfer of the node. For that purpose the control system transmits multicast packets assigned to all nodes of the server. The packet includes a time code, the stream figures, and the alternation status of the nodes in relation to the time code. The alternation status informs the node of allowable transmit directions in time so that after receipt of the multicast packet each node knows which stream figure it must use, the time instant when it must change the stream figure, and the new stream figure.

If the data speed of the internal links is 4 Mbps, then the centralized control system may be realized as a 10 Mbps Ethernet controller, which can handle the alternation well. Two 4 Mbps data streams can alternate in one link. The general principle is that number V of alternations multiplied by the maximum data rate S of the flow must be less than the transfer capacity C of the link, i.e. V*S<C.

On the other hand, the number V of alternations must be less than or equal to the number of users connected to the node. For that reason a plurality of alternative routes, i.e. stream figures, is advantageous when several users are connected to the same node.

Generally, the nodes that perform similar conversion tasks or store similar conversion results are located near each other in the server topology to form a node group. The user terminals that require same kind of conversion are connected to the same node group. The arrangement is favorable because when a terminal requests a certain conversion it is very likely that some node of the node group has already done the conversion for some other user terminal and the conversion result is still obtainable from the memory of that node.

There are two basic approaches for connecting a user terminal to the server. In the first approach the terminal can be connected to whichever “free” node or to whichever node group. In the second approach the server looks for the most suitable node and connects the terminal to that node. The user terminal can have been previously connected to that node or to a node locating near that node. In that case the material requested by the terminal already exist in the server's memory. The server can select the most suitable node also based on the content of the file requested by the terminal. If conversion requires services offered at a higher level, the terminal is connected to a node offering the shortest transmission path to said services.

The invention is primarily intended to provide a sustained data transfer to a plurality of simultaneous users. Hence, the invention is particularly suited for use in video-on-demand systems in which a single server may provide services to even several thousand users. Simultaneously, an improved fault tolerance of the server is attained, because a server consisting of several nodes may now be inexpensively constructed with the additional advantage that no single-node failure can halt the function of the entire server system.

1. A file server system for distributing files to user terminals connected to the server, comprising:
a plurality of nodes, each including a data storage means for storing files, and at least one data connection for communicating with a user connected to the node and having limited capacity to process files;
a plurality of internal links for connecting each node to at least two other nodes;
each node including means for routing
a formatted file received from one of the internal links to the node;
a file stored in the data storage to at least one of the internal links, and
a file received from one of the internal links and destined for another node to another internal link;
characterized in that:
the node includes conversion means for converting a formatted file routed to the node into another format prior to delivery of the file to a user terminal, converted data are stored on the hard disk if the rate of data incoming from an internal link is higher than the bandwidth of the communication link between the file server and the user terminal but sufficient to carry out conversion at the minimum speed required for presentation and when the amount of converted data file is smaller than the amount of unconverted data,
the nodes including same kind of conversion means are located physically near each other to form a node group.

2. A file server system as in claim 1, wherein conversion means perform a file type conversion.

3. A file server system as in claim 1, wherein conversion means perform protocol conversion.

4. A file server system as in claim 1, wherein converted data are transmitted directly to the user without buffering on the hard disk if data rate incoming to the node is slower than the bandwidth of the internal link and conversion can be performed at the minimum rate required for presentation.

5. A file server system as in claim 1, wherein a piece of converted data is buffered on the hard disk if the incoming data rate is slower than the bandwidth of the internal link but conversion cannot be performed at the minimum rate required for presentation.

6. A file server system as in claim 1, wherein conversion means in each of the nodes are identical.

7. A file server system as in claim 1, wherein a plurality of nodes are designated to given conversion tasks, whereupon these nodes means offer conversion capacity to the rest of the nodes.

8. A file server system as in claim 1, wherein during data transfers among the nodes routes, the data transfer routes are alternated in a predetermined way.

9. A file server system as in claim 1, wherein user terminals requesting same kind of conversion are connected to the same node group.
